(19) United States
(12) Patent Application Publication
(10) Pub. No.: US 2008/0238989 A1
(43) Pub. Date: Oct. 2, 2008

(54) Liquid discharging device

(75) Inventor: Shunji Yamaguchi, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION

(21) Appl. No.: 12/072,313

(22) Filed: Feb. 26, 2008

(30) Foreign Application Priority Data
Mar. 30, 2007 (JP) P2007-095320

(51) Int. Cl. B41J 2/165

(52) U.S. Cl. 347/32

(57) ABSTRACT

A liquid discharging device includes a line head having a plurality of discharge ports for discharging liquid, the discharge ports being arranged substantially in lines in a discharge surface; a head cap facing the line head, for closing the discharge ports; and a lift mechanism for lifting or lowering the head cap. The head cap closes the discharge ports by being lifted with the lift mechanism substantially perpendicularly to the discharge surface. Also, the head cap comes away from the discharge surface by being lowered with the lift mechanism substantially perpendicularly to the discharge surface to allow a recording medium to be carried between the head cap and the discharge surface.

### CROSS REFERENCES TO RELATED APPLICATIONS

The present invention contains subject matter related to Japanese Patent Application JP 2007-095320 filed in the Japanese Patent Office on Mar. 30, 2007, the entire contents of which are incorporated herein by reference.

### BACKGROUND OF THE INVENTION

1. Field of the Invention

The present invention relates to a liquid discharging device having a head cap for closing and protecting discharge ports of a line head in which the discharge ports for discharging liquid are arranged substantially in lines.

2. Description of the Related Art

Ink jet printers (hereinafter, referred to as printers) print images and characters by discharging ink from ink discharge heads onto recording sheets. The ink jet printers have advantages of low operating cost, small device size, and easy color image printing.

In such a printer, ink is supplied from an ink tank to an ink chamber of an ink discharge head. The ink chamber contains a pressure generating element, such as a heating resistor or a piezoelectric element. Pressure is applied to the ink in the ink chamber by the pressure generating element, and the ink is discharged from fine discharge ports, that is, nozzles, in droplet form. The discharged ink droplets land on a recording sheet or the like. Hence, the printer prints an image or a character on the recording sheet.

In such a printer, the ink discharge head is finely manufactured, and thus the ink discharge head should be protected. In particular, the nozzles for discharging ink and the vicinity thereof are protected with an openable/closable head cap. In the printer, the head cap is arranged at a position facing a discharge surface having the nozzles. When printing is not performed (standby state), the head cap closes the nozzles, and when printing is performed, the head cap comes away from the discharge surface to open the nozzles and discharge ink. Accordingly, the nozzles can be prevented from being dried, and dusts, paper dusts, and the like, can be prevented from adhering to the nozzles when printing is not performed (standby state). Thus, problems such as clogging can be prevented from occurring.

Printers include a serial head printer and a line head printer. In the serial head printer, an ink discharge head discharges ink while being mainly moved in a width direction of a recording sheet to perform printing for a line, and the ink discharge head and the recording sheet are relatively scanned to perform printing for a sheet. The line head printer includes a long ink discharge head having a width substantially similar to a width of a recording sheet. The ink discharge head discharges ink for a line at a time, and only the recording sheet is moved to perform printing for a sheet.

In particular, in the line head printer having a wide discharge surface as compared with the serial head printer, a plurality of nozzles are provided substantially in lines along the width direction of the recording sheet. Hence, a head cap for protecting the nozzles, and a capping mechanism for driving the head cap may become large. In the line head printer, for example, the ink discharge head and/or the head cap may be movably arranged, so that the ink discharge head and/or the head cap may be moved between a capping position and a retraction position, to perform capping or uncapping.

Since such a printer moves the ink discharge head and/or the head cap for capping or uncapping, the movement may take an extra time. The nozzles and the discharge surface may not be reliably protected, and drying of the nozzles and adhesion of foreign substances such as dusts to the nozzles may be increased. Also, such a printer has to have a carriage path, a carriage mechanism, and the like, for moving the ink discharge head and/or the head cap. The size and cost of the device may be increased.

For example, as disclosed in Japanese Unexamined Patent Application Publication No. 2004-262020, a line head printer includes a carrying belt having an opening, for carrying a sheet, and a maintenance unit provided at a surface facing an ink discharge surface and having a cap member for closing the ink discharge surface. The cap member is vertically moved to the discharge surface through the opening of the carrying belt, so as to cap the nozzles.

With this printer, discharge ports may be capped merely by vertically moving the cap member to the discharge ports through the opening of the carrying belt. The extra time for capping or uncapping is not necessary at completion or start of printing.

However, with the printer, the opening of the carrying belt has to be moved to a position corresponding to the maintenance unit at every capping, which takes an extra time. The nozzles may be dried and foreign substances such as dusts may adhere to the nozzles during that time.

### SUMMARY OF THE INVENTION

In light of the above situation, it is desirable to provide a liquid discharging device capable of reducing a time for opening or closing discharge ports, so as to prevent the discharge ports from being dried, and to prevent dusts, paper dusts, and the like, from adhering to the discharge ports.

A liquid discharging device according to an embodiment of the present invention includes a line head, a head cap, and a lift mechanism. The line head has a plurality of discharge ports for discharging liquid. The discharge ports are arranged substantially in lines in a discharge surface. The head cap faces the line head, and closes the discharge ports. The lift mechanism lifts or lowers the head cap. The head cap closes the discharge ports by being lifted with the lift mechanism substantially perpendicularly to the discharge surface. Also, the head cap comes away from the discharge surface by being lowered with the lift mechanism substantially perpendicularly to the discharge surface to allow a recording medium to be carried between the head cap and the discharge surface.

In the embodiment of the present invention, the head cap for closing the discharge ports is provided to face the plurality of discharge ports arranged in substantially parallel lines of the line head. The head cap opens or closes the discharge ports by being lifted or lowered with the lift mechanism substantially perpendicularly to the discharge surface. With the embodiment of the present invention, since the head cap opens or closes the discharge ports merely by being lifted or lowered substantially perpendicularly to the discharge surface, the discharge ports can be opened or closed in a short time. Also, the discharge ports can be prevented from being dried, and foreign substances, such as dusts and paper dusts, can be prevented from adhering to the discharge ports.

### BRIEF DESCRIPTION OF THE DRAWINGS

FIG. 1 is a perspective view showing the inside of a liquid discharging device to which the present invention is applied;

FIG. 2A is a plan view showing a discharge surface of a liquid discharge head, and FIG. 2B is a plan view showing a head cap;

FIG. 3 is a cross section showing a state in which a recording sheet is carried to a portion between the liquid discharge head and the head cap and printing is performed;

FIG. 4 is a cross section showing a state, in which nozzle units of the liquid discharge head are closed with the head cap;

FIG. 5 is an exploded perspective view showing the head cap;

FIG. 6 is an exploded perspective view showing a cap base;

FIG. 7 is a cross section showing the cap base;

FIG. 8 is a perspective view showing the head cap; and

FIG. 9 is a perspective view showing a lift mechanism of the head cap.

### DESCRIPTION OF THE PREFERRED EMBODIMENTS

An ink jet printer (hereinafter, referred to as a printer) 1, to which the present invention is applied, is described below in details with reference to the drawings.

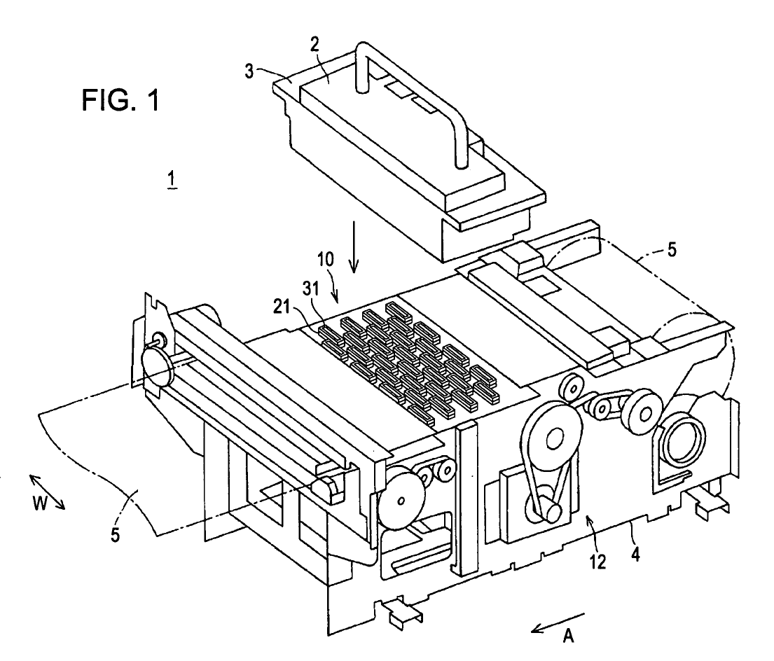

As shown in FIG. 1, the printer 1 is a line printer, in which ink discharge ports (nozzles) 7 are provided in a width direction of a rolled recording sheet 5, i.e., in a direction indicated by arrow W in FIG. 1. The nozzles 7 are arranged in substantially parallel lines respectively for colors. The printer 1 includes a head cartridge 3 and a device body 4 to which the head cartridge 3 is detachably attached. An ink cartridge 2 has ink tanks for yellow (Y), magenta (M), cyan (C) and black (K), and is attached to the head cartridge 3. The head cartridge 3 discharges ink.

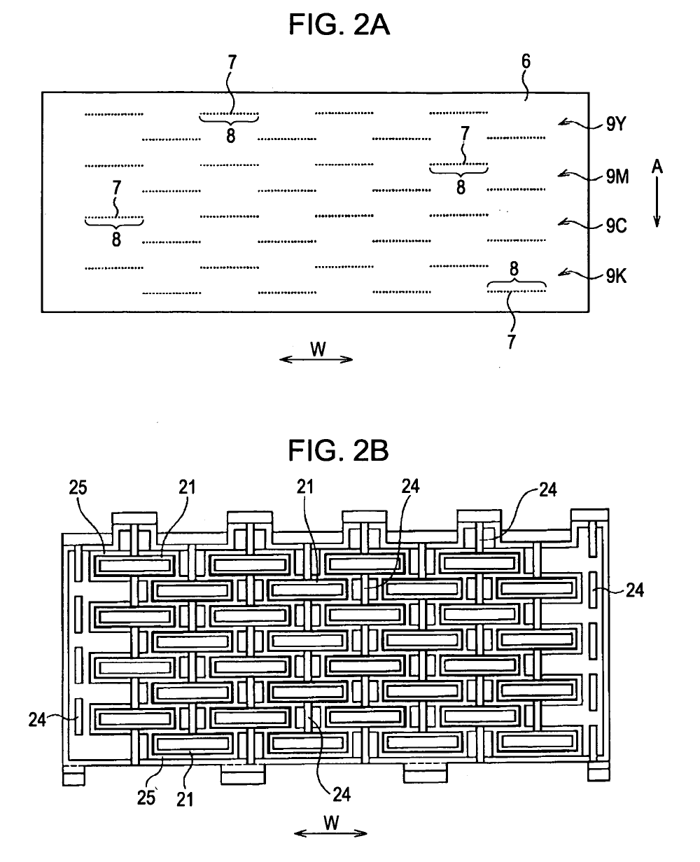

The head cartridge 3 of the printer 1 is attached and fixed to the device body 4. The head cartridge 3 has a heating resistor, which heats ink supplied from the attached color ink tanks to cause air bubbles to be generated, and ink is discharged by the pressure of the air bubbles. As shown in FIG. 2A, a discharge surface 6 of the head cartridge 3, from which ink is discharged, has a plurality of nozzles 7 for discharging ink. A given number of nozzles 7 define a unit 8 (hereinafter, referred to as a nozzle unit 8). A plurality of nozzle units 8 are arranged in a width direction of the recording sheet 5, i.e., in a direction indicated by arrow W in FIG. 2A, in a substantially staggered manner, that is, are arranged in substantially parallel lines. In the head cartridge 3, a yellow nozzle array 9Y, a magenta nozzle array 9M, a cyan nozzle array 9C, and a black nozzle array 9K (hereinafter, also merely referred to as a nozzle array 9) are arranged in a carrying direction of the recording sheet 5, i.e., in a direction indicated by arrow A in FIG. 1. In particular, the yellow nozzle array 9Y, the magenta nozzle array 9M, the cyan nozzle array 9C, and the black nozzle array 9K are arranged in the discharge surface 6 of the head cartridge 3 sequentially in the order from the upstream side to the downstream side in the carrying direction of the recording sheet 5.

The head cartridge 3 discharges ink from the nozzle arrays 9Y, 9M, 9C, and 9K without moving in the width direction of the recording sheet 5. The head cartridge 3 does not have to move the printer head unlike a serial printer that performs printing while moving a printer head in a width direction of a recording sheet 5. Also, the head cartridge 3 allows the recording sheet 5 to be continuously carried, thereby markedly reducing a printing time.

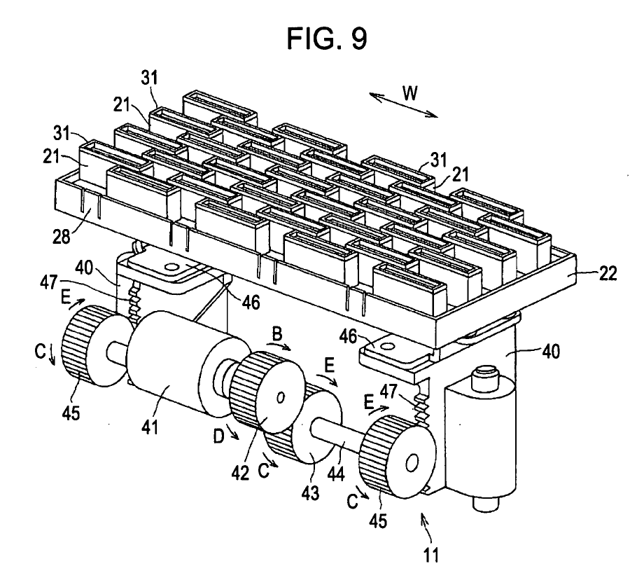

As shown in FIGS. 1 and 9, the device body 4, to which the head cartridge 3 is attached, includes a head cap 10 for protecting the nozzles 7 of the head cartridge 3, a lift mechanism 11 for lifting or lowering the head cap 10, and a carriage mechanism 12 for carrying the recording sheet 5.

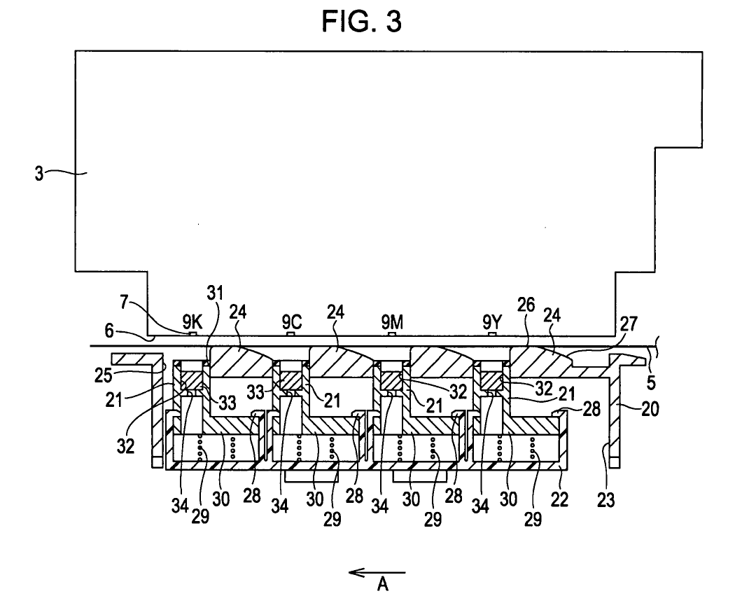

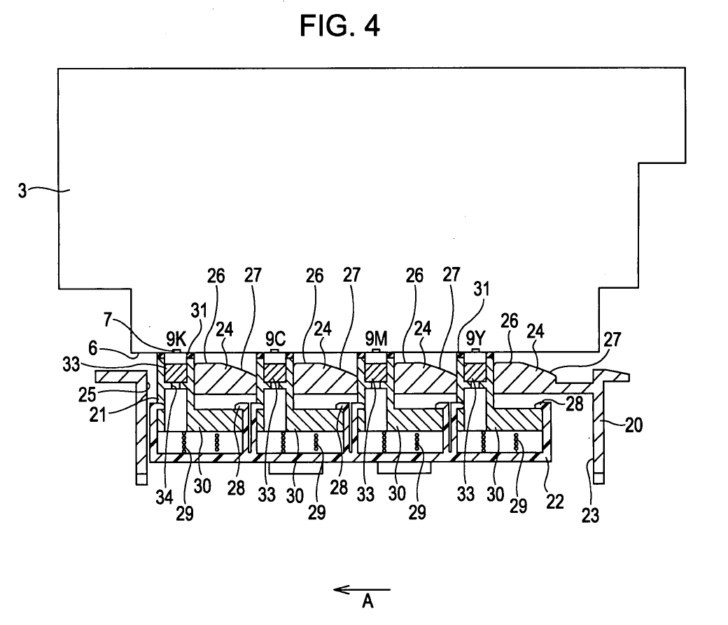

The head cap 10 closes the nozzles 7 of the head cartridge 3, so as to prevent the nozzles 7 from being dried, and to prevent foreign substances such as dusts from adhering to the nozzles 7. As shown in FIG. 2B, the head cap 10 has cap portions 21 corresponding to the nozzle units 8. The cap portions 21 close the nozzle units 8. As shown in FIG. 3, while ink is discharged and printing is performed, the head cap 10 is apart from the discharge surface 6 and is waiting at a position facing the discharge surface 6, to open the nozzle units 8. As shown in FIG. 4, after printing is completed, the head cap 10 is lifted substantially perpendicularly to the discharge surface 6 to close the nozzle units 8 and protect the nozzles 7.

As shown in FIGS. 3 and 4, the head cap 10 is provided at a position facing the discharge surface 6, and includes a reservoir 20 that supports carriage of the recording sheet 5, and a cap base 22 having the cap portions 21 for closing the nozzle units 8.

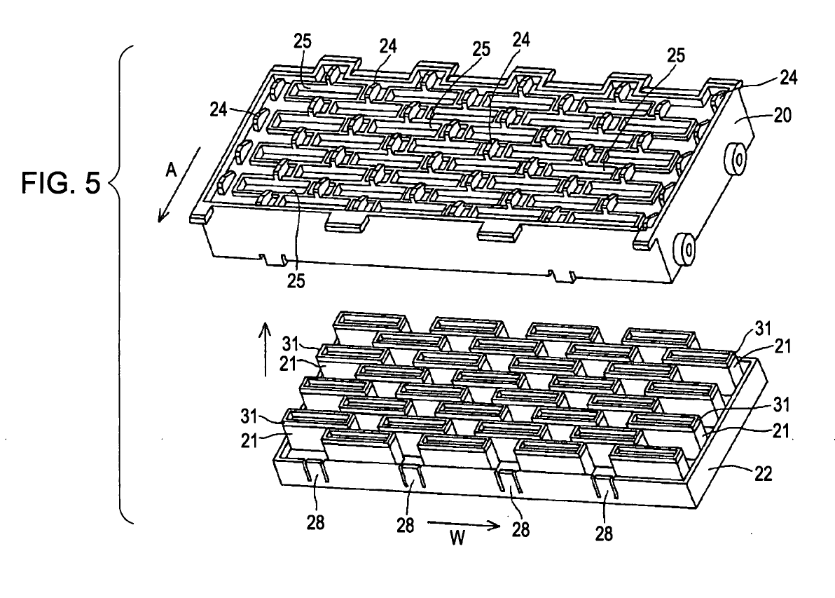

As shown in FIG. 5, the reservoir 20 has a substantially box-like shape to which the cap base 22 may be inserted. The reservoir 20 has, at its bottom surface, an opening 23, to which the cap base 22 is inserted. Also, the reservoir 20 includes, at its upper surface, a plurality of support pieces 24 serving as a plurality of supporting portions for supporting the recording sheet 5 which is carried between the discharge surface 6 and the head cap 10; and a plurality of insertion holes 25, through which the cap portions 21 are inserted. The reservoir 20 is fixed to the device body 4 by screwing or fitting.

The support pieces 24 protrude on the upper surface of the reservoir 20 in regions not occupied by the insertion holes 25. The support pieces 24 are provided in the width direction (W direction) of the recording sheet 5 in a substantially staggered manner, in regions not overlapping the nozzle units 8, that is, regions not facing the nozzle units 8. As shown in FIG. 3, each of the support pieces 24 has a flat portion 26 that supports the carried recording sheet 5, and a guide portion 27 that is continuously formed with the flat portion 26, to guide the leading edge of the carried recording sheet 5 to the flat portion 26. The flat portion 26 is substantially parallel to the discharge surface 6, and supports the carried recording sheet 5 so that the recording sheet 5 becomes substantially parallel to the discharge surface 6. The guide portion 27 is inclined to have a height increasing from the upstream side to the downstream side in the carrying direction of the recording sheet 5. Accordingly, the guide portion 27 lifts the leading edge of the carried recording sheet 5 from the upstream side to the downstream side, and guides the leading edge to the flat portion 26. Since the carried recording sheet 5 is guided by the guide portion 27 to the flat portion 26 and carried on the flat portion 26, the recording sheet 5 can be carried in substantially parallel to the discharge surface 6, thereby improving the carriage of the recording sheet 5. Also, since the support pieces 24 are provided in a staggered manner at the positions facing the discharge surface 6, the recording sheet 5 can be prevented from being deformed at the regions not provided with the support pieces 24, as compared with a case in which support pieces 24 are provided substantially in lines. The supporting portions are not limited to the support pieces 24, and may be rollers or the like instead of the support pieces 24, as long as the supporting portions can support the recording sheet 5 from below.

The above-described reservoir 20 is a member serves as a platen. The reservoir 20 is apart from the discharge surface 6 of the head cartridge 3 by a space for carrying the recording sheet 5, and fixed to the device body 4.

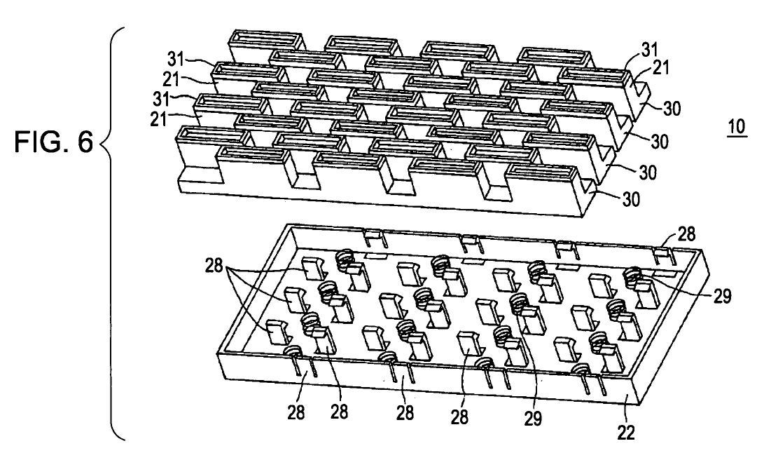

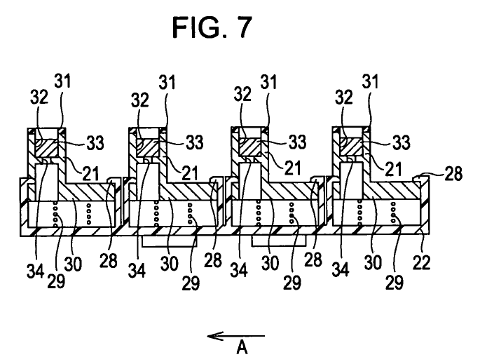

As shown in FIGS. 6 and 7, the cap base 22 has a long, substantially box-like shape. The cap base 22 includes a plurality of engagement pieces 28 which protrude from the bottom surface of the cap base 22 to alternately face each other. The engagement pieces 28 engage with the cap portions 21 for closing the nozzle units 8. The cap base 22 is made of resin or the like by molding. The cap portions 21 are attached to the cap base 22 with resilient bodies, for example, coil springs 29 interposed therebetween. Since the cap portions 21 are attached to the cap base 22 with the coil springs 29 interposed therebetween, the cap portions 21 are pressed to the discharge surface 6 and close the nozzle units 8. Hence, the head cap 10 can enhance the sealing. Also, the engagement pieces 28 alternately face each other to correspond to the cap portions 21. The engagement pieces 28 have substantially L-like shapes at upper ends thereof. The engagement pieces 28 engage with the cap portions 21 to hold the cap portions 21 at predetermined positions, so that the cap portions 21 urged toward the discharge surface 6 by way of the coil springs 29 do not move toward the discharge surface 6 from the predetermined positions.

Each of the cap portions 21 attached to the cap base 22 has a substantially long ring shape surrounding the nozzle unit 8 to close the nozzle unit 8 in the discharge surface 6. As shown in FIG. 2B, the plurality of cap portions 21 are arranged in a substantially staggered manner corresponding to the plurality of nozzle units 8 arranged in a substantially staggered manner. The plurality of cap portions 21 are integrally formed with bases 30, the bases 30 being respectively provided for the nozzle arrays 9Y, 9M, 9C, and 9K.

To enhance the sealing between the cap portion 21 and the discharge surface 6, a flexible rubber lip 31 is attached to an upper end of each cap portion 21, the upper end coming into contact with the discharge surface 6.

Also, the cap portion 21 has a recess at an end portion thereof near the discharge surface 6, the recess serving as a groove 32. An ink absorbing body 33 capable of absorbing ink is provided in the groove 32. Since the cap portion 21 has the ink absorbing body 33 in the groove 32, the cap portion 21 can absorb idly discharged ink during the closed state. Also, a through hole 34 is formed in a bottom surface of the groove 32. The through hole 34 allows ink, which was not absorbed with the ink absorbing body 33 and remained at the bottom surface, to be removed.

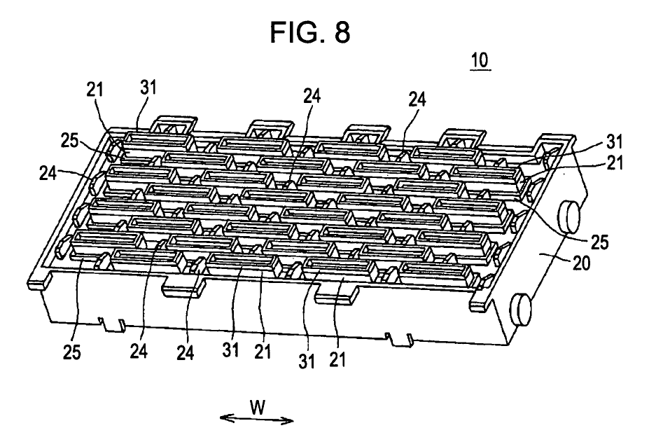

As shown in FIG. 8, the above-described head cap 10 is formed by attaching the cap base 22 to the reservoir 20. In particular, the cap base 22 is inserted to the opening 23 formed in the bottom surface of the reservoir 20, and the cap portions 21 are inserted through the insertion holes 25 of the reservoir 20 to protrude from the insertion holes 25. In the head cap 10, the cap base 22 can slide relative to the upper surface of the reservoir 20 while the cap portions 21 are inserted through the insertion holes 25 of the reservoir 20.

In the head cap 10, while the cap portions 21 are attached to the cap base 22 with the coil springs 29 interposed therebetween, it is not limited thereto. The coil springs 29 may be omitted, the cap base 22 and the cap portions 21 may be integrally formed, and the rubber lips 31 attached to the openings of the cap portions 21 may be replaced with ones having higher elasticity, to enhance the sealing between the head cap 10 and the discharge surface 6.

In the head cap 10, as shown in FIG. 9, the lift mechanism 11 for lifting or lowering the cap base 22 includes sliders 40 attached to a surface opposite to the surface provided with the cap portions 21 of the cap base 22, a driving motor 41 for driving lifting or lowering of the sliders 40, a first gear 42 attached to a rotation shaft of the driving motor 41, a second gear 43 meshing with the first gear 42, and third gears 45 attached to both ends of a shaft 44 to which the second gear 43 is attached.

The sliders 40 are provided at both ends of the cap base 22 in the width direction of the recording sheet 5. Each slider 40 has, at its upper end, an attachment portion 46 attached to the cap base 22. The cap base 22 is attached to the attachment portions 46 of the sliders 40, for example, by screwing. The sliders 40 also have racks 47 vertically extending along ends near the third gears 45 to mesh with the third gears 45.

In the lift mechanism 11, the driving motor 41 rotates normally or reversely to rotate the first gear 42 normally or reversely. The driving force is transmitted from the first gear 42 to the second gear 43. The shaft 44 with the second gear 43 attached is rotated normally or reversely. Accordingly, the third gears 45 are rotated normally or reversely, and hence, the sliders 40 are vertically moved. In the lift mechanism 11, with the vertical movement of the sliders 40, the cap base 22 attached to the sliders 40 can be vertically moved.

A method of opening or closing the nozzle units 8 by lifting or lowering the cap base 22 is described below.

To lift the cap base 22 and close the nozzle units 8 with the cap portions 21, as shown in FIG. 9, the driving motor 41 is normally rotated. This rotates the first gear 42 in a direction indicated by arrow B in FIG. 9, the second gear 43 in a direction indicated by arrow C in FIG. 9, and then the shaft 44 in the direction indicated by arrow C. The third gears 45 at both ends are rotated in the direction indicated by arrow C, and move from the upper ends to the lower ends of the racks 47 of the sliders 40. The sliders 40 move upward, that is, they move toward the discharge surface 6 substantially perpendicularly to the discharge surface 6. The cap base 22 attached to the sliders 40 slides relative to the fixed reservoir 20 and moves toward the discharge surface 6 substantially perpendicularly to the discharge surface 6. The cap portions 21 further protrude to the discharge surface 6 through the insertion holes 25 to a position higher than the position of the support pieces 24 provided at the reservoir 20. As shown in FIG. 4, the rubber lips 31 are closely attached to the discharge surface 6, and the cap portions 21 close the nozzle units 8.

To open the nozzle units 8, as shown in FIG. 9, the driving motor 41 reversely rotates the driving shaft, in a manner opposite to lifting of the cap base 22. This rotates the first gear 42 in a direction indicated by arrow D in FIG. 9, the second gear 43 in a direction indicated by arrow E in FIG. 9, and then the shaft 44 in the direction indicated by arrow E. The third gears 45 provided at both ends of the shaft 44 are rotated in the direction indicated by arrow E, and move from the lower ends to the upper ends of the racks 47 of the sliders 40. Thus, the sliders 40 move downward, that is, in a direction away from the discharge surface 6 substantially perpendicularly to the discharge surface 6. The cap base 22 attached to the sliders 40 slides relative to the fixed reservoir 20, and comes away from the discharge surface 6 substantially perpendicularly to the discharge surface 6. The cap portions 21 enter the reservoir 20 through the insertion holes 25. The cap portions 21 move to a position lower than the position of the support pieces 24 provided at the reservoir 20. As shown in FIG. 3, the cap portions 21 are apart from the discharge surface 6, and open the nozzle units 8.

The device body 4 includes, in addition to the above-described head cap 10 and lift mechanism 11, the carriage mechanism 12 that carries the recording sheet 5. As shown in FIG. 1, the carriage mechanism 12 includes a plurality of driving rollers and a plurality of carrying belts. The carriage mechanism 12 carries the recording sheet 5 to a portion between the head cartridge 3 and the head cap 10, so that ink may be discharged from the head cartridge 3 onto the recording sheet 5 for printing.

With the printer 1 having the above-described arrangement, to close the nozzle units 8 after printing, the driving motor 41 is normally rotated. This rotates the first gear 42 in the direction indicated by arrow B in FIG. 9, and the second gear 43 and the third gears 45 in the direction indicated by arrow C in FIG. 9. With the rotation of the third gears 45, the meshing between the third gears 45 and the racks 47 of the sliders 40 move from the upper ends to the lower ends of the racks 47. Thus, the sliders 40 move toward the discharge surface 6 substantially perpendicularly to the discharge surface 6, the cap portions 21 protrude to the discharge surface 6 to a position higher than the position of the support pieces 24, and the rubber lips 31 are closely attached to the discharge surface 6, thereby closing the nozzle units 8 with the cap portions 21.

With such a printer 1, the head cap 10 having a simple structure is arranged to face the discharge surface 6. The nozzle units 8 can be closed merely by lifting the cap base 22 substantially perpendicularly to the discharge surface 6. The nozzle units 8 can be closed in a short time. Accordingly, with the printer 1, the nozzle units 8 can be closed immediately after printing. The nozzles 7 can be prevented from being dried, and foreign substances, such as dusts and paper dusts, can be prevented from adhering to the nozzles 7.

Also, with the printer 1, since the nozzle units 8 can be closed in a short time, the nozzle units 8 can be closed even when an interval between printing operations is short. The nozzle units 8 can be closed with the cap portions 21 frequently, and hence, drying of the nozzles 7 and adhesion of dusts to the nozzles 7 can be reliably prevented.

In the printer 1, while the nozzle units 8 are closed with the cap portions 21, ink may be idly discharged to the grooves 32 of the cap portions 21, for example, immediately before printing is started, so that thickened ink in the nozzles 7 may be discharged. In the printer 1, after the idle discharging, the ink absorbing bodies 33 in the grooves 32 absorb the ink. Thus, humidity of the grooves 32 can be kept and the nozzles 7 can be prevented from being dried because of the absorbed ink while the discharge surface 6 is closed.

Also, in the printer 1, since the nozzle units 8 are individually closed, the nozzles 7 can be reliably closed.

As shown in FIG. 9, in the printer 1, to perform printing when the nozzle units 8 being closed, as described above, the driving motor 41 is reversely rotated. This rotates the first gear 42 in the direction indicated by arrow D in FIG. 9, and the second gear 43 and the third gears 45 in the direction indicated by arrow E in FIG. 9. With the rotation of the third gears 45, the meshing between the third gears 45 and the racks 47 of the sliders 40 move from the lower ends to the upper ends of the racks 47. Thus, the sliders 40 come away from the discharge surface 6 substantially perpendicularly to the discharge surface 6. With this arrangement, the cap base 22 with the sliders 40 comes away from the discharge surface 6 substantially perpendicularly to the discharge surface 6. The cap portions 21 enter the insertion holes 25. The cap portions 21 move to a position lower than the position of the support pieces 24 provided at the reservoir 20. As shown in FIG. 3, the cap portions 21 are apart from the discharge surface 6, and open the nozzle units 8. At this time, in the printer 1, the recording sheet 5 is carried to a portion just before the head cartridge 3, and the recording sheet 5 is carried to a portion between the discharge surface 6 and the head cap 10 immediately after the nozzle units 8 are opened. In the printer 1, the carried recording sheet 5 is supported by the flat portions 26 of the support pieces 24 facing the discharge surface 6. The recording sheet 5 is carried without coming into contact with the cap portions 21 while being held in substantially parallel to the discharge surface 6. In the printer 1, the head cartridge 3 discharges ink onto the carried recording sheet 5 for printing.

With the printer 1, the nozzle units 8 can be opened immediately after the cap base 22 comes away from the discharge surface 6. Accordingly, if the cap base 22 comes away from the discharge surface 6 when the recording sheet 5 is carried to the position just before the bead cartridge 3, printing can be performed. With the printer 1, the nozzles 7 are closed with the cap portions 21 till a time immediately before the nozzles 7 discharge ink. Thus, the ink can be discharged without the nozzles 7 being dried, and without dusts and the like adhering to the nozzles 7. The printer 1 can print a high quality image without problems such as irregular discharging of the nozzles 7, or without unprinted spots and the like.

Also, with the printer 1, the nozzle units 8 can be closed or opened by the cap base 22 in a short time. For example, to discontinuously print a plurality of images, the nozzle units 8 may be closed, and the nozzles 7 may perform idle discharging to the grooves 32 of the cap portions 21, during an interval between printing operations. Accordingly, foreign substances such as dusts entering the nozzles 7 can be removed, and the nozzles 7 can be moisturized. Thus, problems with the nozzles 7 can be prevented from occurring.

To discontinuously print a plurality of images, if it is determined that a total printing time of images exceeds a predetermined time(=T), the nozzle units 8 may be closed when the predetermined time T has elapsed, and may be controlled to perform idle discharging to the grooves 32 of the cap portions 21, so as to remove foreign substances such as dusts entering the nozzles 7, and to moisturize the nozzles 7. Accordingly, even when the printer 1 performs printing after the predetermined time has elapsed, the nozzle units 8 may be properly closed, so that the nozzles 7 are moisturized and foreign substances are removed. Thus, the problems with the nozzles 7 can be prevented from occurring.

With this printer 1, since the cap base 22 does not move in a wide range, a space and a large drive mechanism for moving the cap base 22 are not necessary. Thus, the space of the device can be saved, and the device can be downsized.

Also, with the printer 1, since only the cap base 22 is moved relative to the discharge surface 6 while the head cartridge 3 is fixed, a given distance between the discharge surface 6 and the recording sheet 5 can be accurately kept. Accordingly, a high quality image can be formed without the position of the head cartridge 3 and the distance between the head cartridge 3 and the recording sheet 5 being adjusted at every printing operation.

Also, in the printer 1, since the head cartridge 3 is continuously fixed, destruction of meniscus of ink in the nozzles 7 can be reduced, ink can be prevented from leaking from the nozzles 7, and air bubbles can be prevented from entering the nozzles 7. Thus, the meniscus of ink in the nozzles 7 can be easily kept.

Also, in the printer 1, even when the line head is employed, and hence, the area of the discharge surface 6 is large, the entire discharge surface 6 can be reliably protected and the nozzles 7 can be easily closed, as described above. The nozzles 7 can be prevented from being dried, and foreign substances such as dusts can be prevented from adhering to the nozzles 7.

In the above-described printer, the head cartridge 3 and the head cap 10 correspond to the width of the recording sheet 5, for example, the widths of A4 and A3 sizes.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid discharging device comprising:
a line head having a plurality of discharge ports for discharging liquid, the discharge ports being arranged substantially in lines in a discharge surface;
a head cap facing the line head, for closing the discharge ports; and
a lift mechanism for lifting or lowering the head cap,
wherein the head cap closes the discharge ports by being lifted with the lift mechanism substantially perpendicularly to the discharge surface, or comes away from the discharge surface by being lowered with the lift mechanism substantially perpendicularly to the discharge surface to allow a recording medium to be carried between the head cap and the discharge surface.

2. The liquid discharging device according to claim 1,
wherein the head cap includes:
a reservoir having a plurality of supporting portions for supporting the carried recording medium, and a plurality of insertion holes provided at positions between the supporting portions and corresponding to the discharge ports; and
a cap base having a plurality of cap portions for closing the discharge ports, the cap base being attached to the reservoir by inserting the cap portions to the insertion holes,
wherein the lift mechanism lifts or lowers the cap base with respect to the reservoir, and
wherein the head cap closes the discharge ports with the cap portions by lifting the cap base with the lift mechanism, or the cap portions comes away from the discharge surface by lowering the cap base with the lift mechanism to allow the recording medium to be carried on the reservoir while the recording medium is supported with the supporting portions.

3. The liquid discharging device according to claim 2, wherein each of the cap portions is formed in a ring shape surrounding the discharge port, and has a liquid absorbing body in the cap portion.

4. The liquid discharging device according to claim 2, wherein the cap portions are attached to the reservoir with resilient bodies interposed therebetween.
